(19) United States
(12) Patent Application Publication
(10) Pub. No.: US 2005/0200752 A1
(43) Pub. Date: Sep. 15, 2005

(54) Image photographing apparatus

(75) Inventor: Nam-il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/048,920

(22) Filed: Feb. 3, 2005

(30) Foreign Application Priority Data
Mar. 10, 2004 (KR) 2004-16191

(51) Int. Cl. H04N 5/225

(52) U.S. Cl. 348/376

(57) ABSTRACT

An image photographing apparatus for recording and reproducing an image of a subject includes a main body and a button unit movably mounted on one side of the main body. The button unit has at least one operation button. A guide member is mounted on the main body to guide movement of the button unit. A user may move and fix the button unit in a desired position, thereby providing a more convenient and stable image photographing apparatus and improving image quality.

### CROSS-REFERENCE TO RELATED APPLICATIONS

This application claims the benefit under 35 U.S.C. § 119(a) of Korean Patent Application No. 2004-16191, filed Mar. 10, 2004, in the Korean Intellectual Property Office, the entire disclosure of which is hereby incorporated by reference.

### BACKGROUND OF THE INVENTION

1. Field of the Invention

The present invention relates to an image photographing apparatus. More particularly, the present invention relates to an image photographing apparatus, such as digital cameras and camcorders, which record an image of an object and reproduce the recorded image or a dual camcorder that functions as both a camera and camcorder.

2. Description of the Related Art

Image photographing apparatuses are typically categorized as a digital camera that records and reproduces a still image, a camcorder that records and reproduces a moving picture, or a dual camcorder that selectively records and reproduces a moving picture and a still image. The image photographing apparatus includes a camera unit having a lens to photograph an image of a subject, a recording medium where the still image or the moving picture is recorded, a viewfinder for enabling a user to view the object received through the camera unit, a recording button for recording an image, and a zoom button for focusing a camera lens.

As the image photographing apparatus becomes widespread, both the recording button and the zoom button are generally mounted at one side of the apparatus for a user to grip and operate by one hand. The mounting position of the buttons, although it is varies between products, is generally determined in consideration of an average size of adults' hands.

Therefore, users whose hands are out of the average size range are inconvenienced by, for example, having to use both hands to grip and operate the image photographing apparatus at the same time.

Moreover, if a user does not grip the apparatus with a hand position intended by the manufacturer, manual operation of the both buttons is inconvenient, and this may induce trembling or shaking of a camera unit, thereby deteriorating the image quality of photographed images.

### SUMMARY OF THE INVENTION

Accordingly, an aspect of the present invention is to provide an image photographing apparatus enabling a convenient manual operation of buttons regardless of a user's hand size or gripping position.

An image photographing apparatus has a main body including a camera lens and a recording medium, a button unit movably mounted on one side of the main body and having at least one operation button, and a guide member mounted on the main body to guide movement of the button unit.

Therefore, the user is able to conveniently operate the button unit according to hand size or gripping position.

The button unit includes a recording button for photographing an image. A zoom button focuses the camera lens. A holder supports the recording button and the zoom button. Preferably, the recording button and the zoom button are positioned for a user to grip the apparatus and operate the buttons using one hand.

The image photographing apparatus may further include a locking unit mounted in the button unit, wherein the locking unit is locked by the guide member so that the button unit may be fixed in a desired position.

The image photographing apparatus may further include a fixing member to fix the button unit to the guide member by tightly contacting the fixing member to the guide member.

According to an embodiment of the present invention, the holder includes a protrusion, and the guide member includes a guide groove disposed at both sides thereof. The protrusion is inserted in the guide groove for movement of the holder.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of an image photographing apparatus according to an embodiment of the present invention, a portion of which is partially cut away;

FIG. 2 is an exploded perspective view of a separated button unit and guide member of FIG. 1;

FIG. 3 is an elevational view in partial cross section of the image photographing apparatus cut along a line III-III of FIG. 1; and

FIG. 4 is a perspective view of the button unit and the guide member of FIG. 1 being connected to each other.

Throughout the drawings, like reference numerals will be understood to refer to like parts, components and structures.

### DETAILED DESCRIPTION OF THE EXEMPLARY EMBODIMENTS

Hereinafter, an embodiment of the present invention will be described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions and elements are not described in detail for conciseness and clarity.

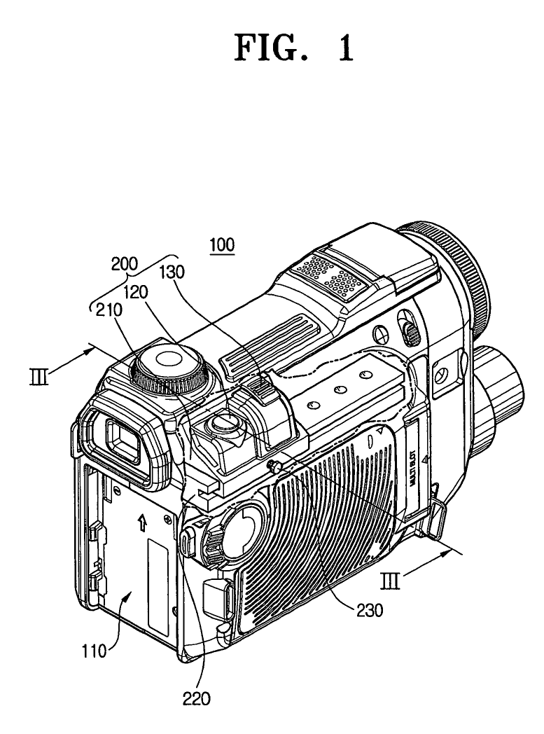

FIG. 1 is a partially cut, perspective view of an image photographing apparatus according to an embodiment of the present invention. The image photographing apparatus 100 includes a main body 110, a button unit 200, a guide member 220, a fixing member 230 and a locking unit 300 (FIG. 3).

The main body 110 includes a camera lens (not shown) and a recording medium (not shown) disposed therein. The button unit 200 inclues a recording button 120 for photographing an image, a zoom button 130 for focusing a lens, and a holder 210 for supporting the recording button 120 and the zoom button 130. Because the holder 210 is slidably mounted on the guide member 220 mounted in the main body 110, a user may control a position of the holder 210 for convenient operation of the recording button 120 and the zoom button 130 mounted on the holder 210 according to the user's hand size or position. The fixing member 230 is mounted on a flank of the holder 210, and the locking unit 300 (FIG. 3) fixes the button unit 200 to the guide member 220. The recording button 120 and the zoom button 130 are electrically connected to the electronics (not shown) in the main body 110 of the image photographing apparatus 100 in a conventional manner, such as by lead lines and/or conductive strips, disposed, for example, at the back surface of the holder 210.

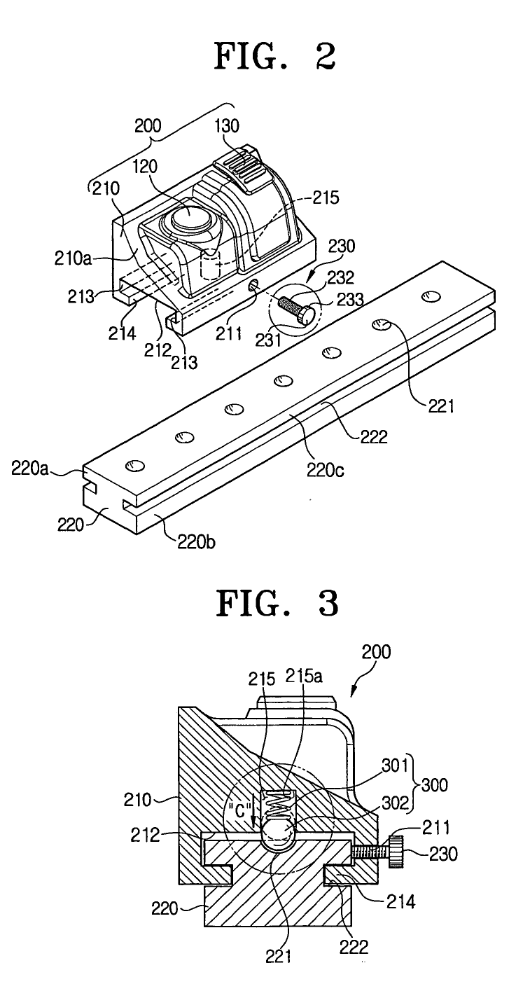

FIG. 2 is an exploded view of the button unit 200, the guide member 220 and the fixing member 230 in a disassembled condition.

The holder 210 has a slanted upper surface 210a for handy operation of the recording button 120 and the zoom button 130. Protrusions 214 extend inwardly from lower parts of opposite sides 213 of the holder. The protrusions 214 are spaced a predetermined distance from a bottom 212 of the holder 210 so that an upper part 220a of the guide member 220 can be inserted in the space defined by the protrusions and the bottom 212 of the holder 210. On the bottom 212 of the holder 210, a locking unit 300 receiving recess 215 is formed upwardly therein to receive the locking unit 300 (FIG. 3). A tap hole 211 is formed in one flank of the holder 210 for insertion of the fixing member 230.

The fixing member 230 has a handle part 231 for a user's manual operation and an inserting part 232 to be inserted in the tap hole 211 of the holder 210. A circumferential side of the handle part 231 is formed as an uneven surface 233 having prominences and depressions to prevent sliding of the user's hand when rotating the handle part 231, thereby providing a gripping surface. The inserting part 232 is formed as a bolt, therefore, as the user rotates the handle part 231 at the tap hole 211, the inserting part 232 proceeds into the tap hole 211, thereby contacting a side surface 220c of the guide member 220. In one embodiment, the fixing member 230 is inserted in the holder 210. Alternatively, the fixing member 230 for fixing the holder 210 may be designed in various manners. For example, the fixing member 230 may be formed as a one-touch type having a spring and a button. Alternatively, the fixing member 230 may fix the holder 210 from a flank side of the holder 210 instead of being inserted in the holder 210.

The guide member 220 has guide grooves 222 at both sides thereof. With respect to the guide grooves 222, the guide member 220 is divided into the upper part 220a and a lower part 220b, as shown in FIG. 2. A plurality of locking recesses 221 are formed on a top surface of the guide member 220 at regular intervals. The locking recesses 221 are formed at short intervals for minute adjustments of the holder 210 position.

The locking unit 300 includes a resilient member 301 and a fastening member. Referring to FIG. 3, preferably the resilient member is a coil spring 301 and the fastening member is preferably a substantially spherical ball 302. The locking unit 300 is mounted in the locking unit receiving recess 215 formed in the bottom 212 of the holder 210 of the button unit 200. The coil spring 301 is fixed on an upper surface 215a of the locking unit receiving recess 215, and the ball 302 is attached to one end of the coil spring 301. The coil spring 301 compresses the ball 302 toward the guide member 220, in a direction indicated by the arrow “C” of FIG. 3 to maintain tight contact of the ball 302 with the guide member 220.

The protrusions 214 of the holder 210 are inserted in the guide grooves 222, thereby connecting the guide member 220 and the button unit 200. The fixing member 230 presses the side surface 220c (FIG. 2) of the guide member 220 as the fixing member passes through the tap hole 211 of the holder 210, thereby fixing the button unit 200 to the guide member 220. The locking unit 300 is locked by the locking recess 221 of the guide member 220.

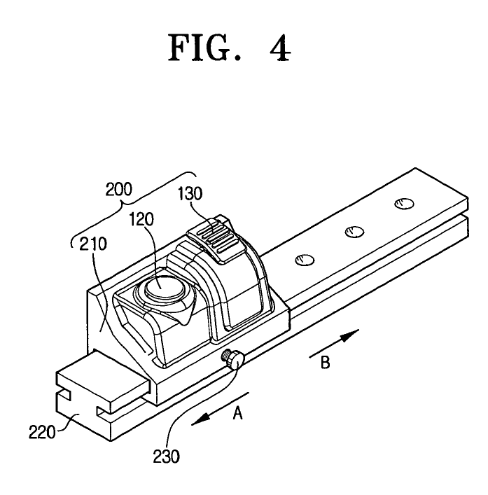

FIG. 4 illustrates the button unit 200 being connected to the guide member 220. When the user operates the recording button 120 and the zoom button 130 while gripping the image photographing apparatus 100 with one hand, the user may control the position of the button unit 200 by moving the button unit 200 in a direction indicated by arrow “A” or in a direction indicated by arrow “B” of FIG. 4 according to the user's hand size. That is, if the user's hand is relatively small, the user may move the button unit 200 in the direction indicated by arrow “A”, and if the user's had is relatively large, the user may move the button unit 200 in the direction indicated by arrow “B”.

In order to move the button unit 200 when in a locked condition, the fixing member 230 is rotated counterclockwise first to space the inserting part 232 of the fixing member 230 from the guide member 220. Then, the button unit 200 may be slid in the direction “A” or “B”. As the button unit 200 slides on the guide member 220, the ball 302 (FIG. 3) inserted in one locking recess 221 (FIG. 2) of the guide member 220 escapes from the locking recess 221 in a sliding manner and is inserted in another neighboring locking recess 221. Accordingly, the user may move the button unit 200 to a desired position.

If the button unit 200 is placed in the desired position, the handle part 231 of the fixing member 230 is rotated clockwise to press the inserting part 232 against the side surface 220c (FIG. 2) of the guide member 220, as shown in FIG. 3, thereby fixing the button unit 200 to the guide member 220.

While the invention has been shown and described with reference to certain embodiments thereof, it will be understood by those skilled in the art that various changes in form and details may be made therein without departing from the spirit and scope of the invention as defined by the appended claims.

1. An image photographing apparatus, comprising:
a main body having a camera lens and a recording medium;
a button unit movably mounted on one side of the main body and having at least one operation button; and
a guide member mounted on the main body and adapted to receive the button unit to guide movement of the button unit thereon.

2. The image photographing apparatus of claim 1, wherein
a recording button is disposed on the button unit to photograph an image;
a zoom button for is disposed on the button unit to focus the camera lens; and
the button unit has a holder to support the recording button and the zoom button.

3. The image photographing apparatus of claim 2, wherein
the holder has a protrusion, and the guide member has a guide groove disposed at both sides thereof adapted to receive the protrusion to guide movement of the holder on the guide member.

4. The image photographing apparatus of claim 1, wherein
a locking unit mounted in the button unit fixes the button unit in a desired position on the guide member.

5. The image photographing apparatus of claim 4, wherein
the button unit has a locking unit receiving recess in a bottom surface thereof, and the locking unit is mounted within the locking unit receiving recess.

6. The image photographing apparatus of claim 5, wherein
the locking unit has a fastening member and a resilient member, the resilient member biasing the fastening member toward the guide member; and
the guide member has a plurality of locking recesses adapted to receive the fastening member.

7. The image photographing apparatus of claim 1, wherein
a fixing member fixes the button unit to the guide member.

8. The image photographing apparatus of claim 7, wherein
the button unit has a tap hole and the fixing member has an inserting part adapted to be inserted in the tap hole, the button unit being fixed to the guide member by the inserting part inserted into the tap hole that contacts the guide member.

9. The image photographing apparatus of claim 8, wherein
a handle part of the fixing member facilitates insertion and removal of fixing member in the tap hole.

10. The image photographing apparatus of claim 6, wherein
the resilient member is a coil spring.

11. The image photographing apparatus of claim 6, wherein
the fastening member is substantially spherical.

12. An image photographing apparatus, comprising:
a main body;
a guide member connected to the main body;
a button unit movably connected to guide member, the button unit having at least one button to operate the image photographing apparauts; and
a fixing member to lock the button unit to the guide member in a desired position.

13. The image photographing apparatus of claim 12, wherein
the guide member is substantially H-shaped.

14. The image photographing apparatus of claim 13, wherein
the guide member has an upper portion and a lower portion with a pair of grooves formed therebetween.

15. The image photographing apparatus of claim 14, wherein
the button unit has a pair of protrusions adapted to be received by the pair of grooves in the guide member to guide movement of the button unit thereon.

16. The image photographing apparatus of claim 12, wherein
a locking unit is secured in a recess formed in a lower surface of the button unit.

17. The image photographing apparatus of claim 16, wherein
the locking unit has a resilient member having a first end secured to the button unit and a second end to which a fastening member is secured.

18. The image photographing apparatus of claim 17, wherein
an upper surface of the guide member has a plurality of second recesses adapted to receive the fastening member to lock the button unit in the desired position on the guide member.

19. The image photographing apparatus of claim 12, wherein
a tap hole in the button unit is adapted to receive a fixing member to prevent movement of the button unit along the guide member.

20. The image photographing apparatus of claim 19, wherein
the fixing member is a fastener, a first end of the fastener being inserted through the tap hole to contact the guide member to prevent movement of the button unit along the guide member.
